(19) United States
(12) Patent Application Publication
(10) Pub. No.: US 2019/0177139 A1
(43) Pub. Date: Jun. 13, 2019

(54) SAFETY SYSTEM AND DEVICE FOR VEHICLES IN MOVEMENT

(71) Applicant: Abdulla Ebraheim Mohamed E. Al Suwaidi, FUJAIRAH (AE)

(72) Inventor: Abdulla Ebraheim Mohamed E. Al Suwaidi, FUJAIRAH (AE)

(21) Appl. No.: 15/835,867

(22) Filed: Dec. 8, 2017

(51) Int. Cl. B66F 9/065

(52) U.S. Cl. CPC B66F 9/0655; B60W 30/09

(57) ABSTRACT

A system for controlling a vehicle encountering a vehicular emergency is disclosed. According to the invention, the system includes a safety vehicle deployed on reception of an emergency notification, which closely follows a vehicle in movement. The safety vehicle enables lifting of the vehicle in movement, using extendable and retractable arm structures fixed on the safety vehicle, wherein a claw structure is coupled to the end of each arm structure. A controller is used for controlling movements of the arm and claw structures.

### FIELD OF THE INVENTION

The present invention relates to a safety device, and more particularly for a safety device to be used with vehicles in movement.

### BACKGROUND OF THE INVENTION

Several incidents have been reported over the past number of years of failed cruise controls and failed brake systems while drivers were moving at over 120 kmph. Non-functioning vehicle brake systems and a sudden failure of the cruise control to disengage are issues that public officials should be ready to encounter when considering the protection of vehicles on the road. Such vehicular emergencies are unpredictable and may be encountered at any undesirable circumstance.

Controlling and saving vehicles which lose control when navigating at high speeds is an even more difficult problem for public officers like the police department. Currently, there are no suitable or safe solutions for this problem. Considering traditional systems, police or public officers on receiving an alert or emergency call, send patrols to escort the driver in danger, to safety. Other methods employed to stop a vehicle with failed brakes or cruise controls involved deploying metal barriers and nails in the vehicle's path or instructing the vehicle to crash into an ambulance or patrol vehicle escorting a vehicle in movement or an uncontrollable vehicle. However, these methods do not ensure safety of the drivers or the patrol officers engaged in the safety operation.

Accordingly, there exists a need to provide a solution which overcomes at least a part of the above disadvantages, for handling vehicular emergencies which pose a threat for fellow drivers.

### SUMMARY OF THE INVENTION

It is an object of the present invention to provide a safety device for lifting a vehicle in movement. The present invention aims at controlling a vehicular emergency, providing safety for passengers within the vehicle in movement as well as public officers engaged in a safety and rescue operation.

The present invention provides a safety device for lifting a vehicle in movement. In one embodiment, the safety device comprises a plurality of arm structures, a plurality of claw structures, a controller for controlling movements of the arm and claw structures. Preferably, the arm structures are extendable and retractable and fixed on a safety vehicle. Preferably, the claw structures are coupled to the arm structures at one end.

In an embodiment, the plurality of arm structures are comprised of steel and the plurality of arm structures are fixed on left and right sides of the safety vehicle or left and right sides of the safety vehicle's roof.

Further, the plurality of arm structures comprise a telescopic structure actuated by a telescopic mechanism, which allows the plurality of arm structures to extend or retract to an arbitrary distance.

In an embodiment, the plurality of arm structures comprise a foldable structure with rotational joints, which allows the plurality of arm structures to unfold and extend or to fold and retract to an arbitrary distance.

In another embodiment, the plurality of arm structures are actuated by a hydraulic mechanism.

In accordance with the present invention, on encountering an emergency situation, the plurality of arm structures extend simultaneously from the safety vehicle.

In another embodiment, the plurality of arm structures comprise at least one imaging device.

Further, the plurality of arm structures comprise at least one sensor, in communication with the controller which controls movements of the plurality of arm and claw structures. The sensors present on the plurality of arm structures are proximity sensors.

In a further embodiment, the plurality of claw structures coupled with the plurality of arm structures are 360-degree rotatable structures.

In another embodiment, the plurality of claw structures coupled with the plurality of arm structures comprises a double tooth structure including at least two teeth, and a distance between the teeth is fixed.

In yet another embodiment, the plurality of claw structures coupled with the plurality of arm structures comprises a double tooth structure including at least two teeth, and a distance between the teeth is variable.

In accordance with the present invention, the safety device further comprises a suction arrangement wherein the suction arrangement is extendable and retractable and fixed on the safety vehicle.

The suction arrangement fixed on the safety vehicle comprises: a telescopic rod structure, a plurality of suction plates and a lifting and lowering mechanism. Preferably, the lowering mechanism presses the plurality of suction plates down on the safety vehicle when the suction arrangement is lowered. One end of the telescopic rod structure is fixed to the safety vehicle and the plurality of suction plates are arranged at an opposite end of the telescopic rod structure.

In accordance with a further aspect of the present invention, the safety vehicle comprises a display on a rear window of the safety vehicle. Preferably, predefined or customized messages are displayed on the display using the controller.

In an embodiment, the controller which controls movements of the plurality of arm and claw structures and display of messages on the safety vehicle's rear window, is located within the safety vehicle.

In accordance with a preferable embodiment of the present invention, a vehicle in movement is an uncontrollable vehicle.

In yet another embodiment, the invention involves a safety system for lifting a vehicle in movement, the safety system comprising: a plurality of arm structures, a plurality of claw structures; a controller for controlling movements of the arm and claw structures. Preferably, the plurality of arm structures are extendable and retractable and fixed on a safety vehicle and the plurality of claw structures are coupled to the plurality of arm structures at one end, the plurality of arm structures extend towards the vehicle in movement, the plurality of claw structures engage with an open window of the vehicle in movement and the vehicle in movement is lifted off the ground.

Additional objects, features and advantages of the invention shall become apparent as the description thereof proceeds when considered in connection with the accompanying illustrative drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a top view of one embodiment of the present invention.

FIG. 2 (a)-2 (d) illustrate a top view of other embodiments of the present invention.

FIG. 3 illustrates a top view of another embodiment of the present invention;

FIG. 4 illustrates is a back perspective view of another embodiment of the present invention.

### DETAILED DESCRIPTION OF THE INVENTION

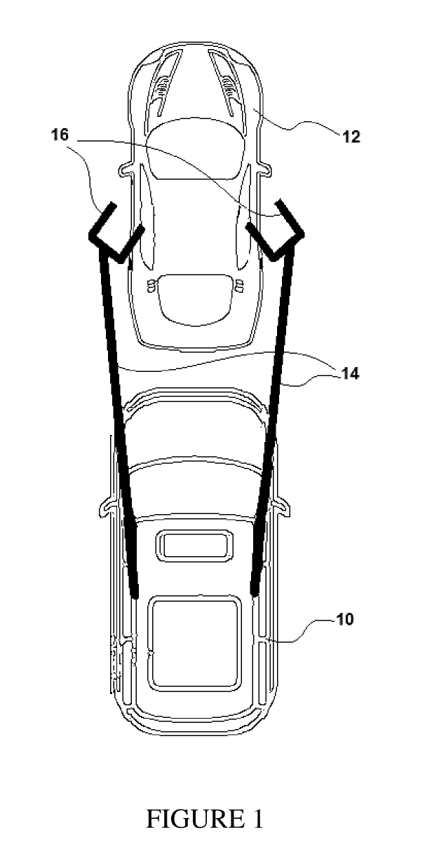

The aspects of the safety device for lifting a vehicle in movement, according to the present invention will be described in conjunction with FIGS. 1-4.

In accordance with the present invention, a safety or rescue vehicle 10 is deployed in an emergency situation to ensure the safety and protection of a vehicle in movement 12 or an uncontrollable vehicle. The safety vehicle includes, but is not limited to, police vehicles, patrol vehicles, fire engines, ambulances, rescue vehicles, ladder trucks or public officers' vehicles. An uncontrollable vehicle in accordance with the present invention is defined as a vehicle that encounters a vehicular emergency which includes, but is not limited to, a non-functioning vehicle brake system, a sudden failure of the cruise control to disengage, failure of power steering functionalities, or other failures resulting in loss of control of movements of the vehicle.

An alert or notification message is sent out by a mobile communication device on detection or encounter of a vehicular emergency. The mobile communication device includes, but is not limited to, cellular telephones, mobile phones, smart phones, wireless devices, game devices, laptop computers, personal information devices, personal data assistants (PDA), hand-held devices, network appliances, internet appliances or two-way pagers. This alert or notification message includes location information of a user of the mobile communication device and is received by a server or a central command and control station which determines the current location of the emergency and dispatches safety vehicles towards the determined location. The alert or emergency notification message is sent out by a passenger within an uncontrollable vehicle or a vehicle in danger or a vehicle in movement, or by a public officer or bystander who witnessed the uncontrollable vehicle or vehicle in movement or vehicular emergency. An Application Programming Interface (API) at the central command and control station enables reception of the alerts or emergency notification messages. On reception of an alert or emergency notification message, a safety vehicle 10 equipped with a safety device in accordance with the present invention, is dispatched towards the vehicle in movement 12.

The terms “arm structures”, and “plurality of arm structures”, which are used interchangeably herein, both refer to the arm structures in accordance with the present invention. Also, the terms “claw structures”, and “plurality of claw structures”, which are used interchangeably herein, both refer to the claw structures in accordance with the present invention.

FIG. 1 is a block diagram showing a general operational environment, according to a preferred embodiment of the present invention. The safety device comprises a plurality of arm structures 14, a plurality of claw structures 16 and a controller for controlling movements of the arm and claw structures. The arm structures 14 are extendable and retractable and are fixed on the safety vehicle 10. The claw structures 16 are coupled with the arm structures 14 at one end of each arm. The dispatched safety vehicle 10 on reaching the emergency location closely follows the vehicle in movement 12 and extends the arm structures 14 towards the vehicle in movement 12. The claw structured ends 16 of the extended arm structures 14 are then engaged with windows of the vehicle in movement 12 and the extended arm structures 14 enable the vehicle in movement 12 to be lifted off the ground.

In an embodiment, the arm structures 14 are fixed on the left and right sides of the safety vehicle 10. These arm structures 14 are extended simultaneously from the left and right sides of the safety vehicle 10 to enable the claw structures 16 to engage with windows on the left and right sides of the vehicle in movement 12 and thus, lifting the left and right sides of the vehicle in movement 12 concurrently. The extendable and retractable arm structures 14 are mechanically fixed on the left and right sides of the safety vehicle 10 using bolts or fasteners or screw jacks wherein the screw is, but not limited to, a machine screw or a ball screw.

In another embodiment, the extendable and retractable arm structures 14 are fixed on the left and right sides of the safety vehicle's roof. The arm structures are extended simultaneously from the left and right sides of the safety vehicle's roof to enable the claw structures 16 to engage with windows on the left and right sides of the vehicle in movement 12 and thus, lifting the left and right sides of the vehicle in movement 12 concurrently. The extendable and retractable arm structures 14 are fixed on the left and right sides of the safety vehicle's roof using bolts or fasteners or screw jacks wherein the screw is, but not limited to, a machine screw or a ball screw.

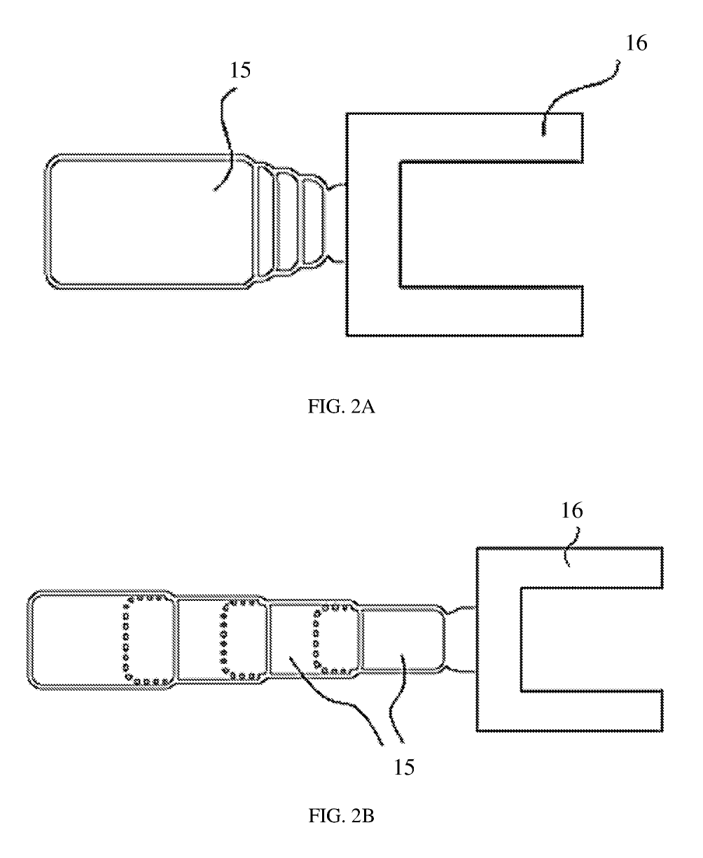

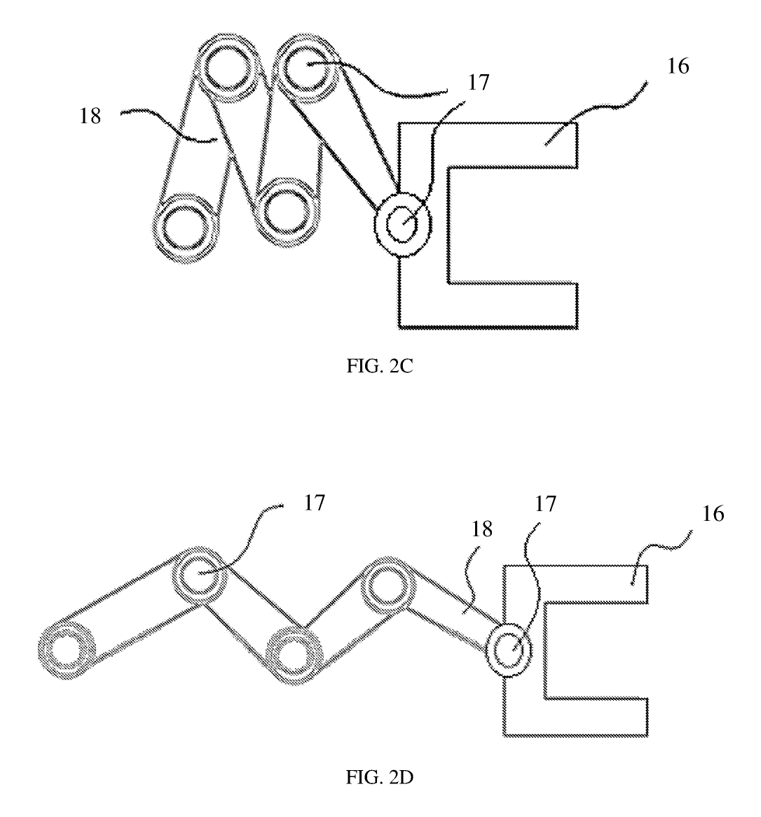

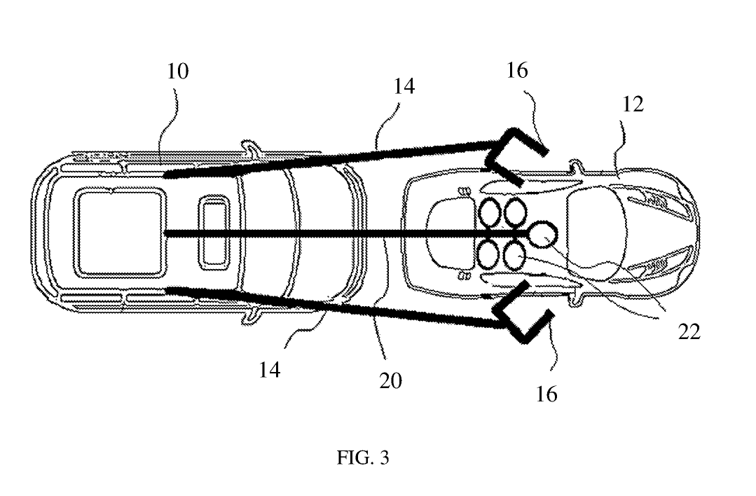

In an embodiment, the arm structures 14 are actuated through a telescopic mechanism. The arm structures 14 comprise a telescopic structure which allows the arm structures to extend or retract to an arbitrary distance, based on a number of telescopic arm sections 15. As shown in FIGS. 2, 2 (a) and 2 (b) depict the telescopic structure of the extendable and retractable arm structures 14. FIG. 2 (a) shows the telescopic arm structure in a retracted form, whereas 2 (b) shows an extended form of the telescopic arm structure. Based on the varying the number of telescopic arm sections 15, the arm is designed to suit particular distance requirements. The telescopic arm structure has the claw structure 16 coupled to an end of the arm structure whereas the other end of the telescopic arm structure is mechanically fixed to the safety vehicle 10 through mechanical means, such as, but not limited to, screw jacks, bolts or fasteners.

In another embodiment, as shown in FIGS. 2 (c) and 2 (d), the arm structures 14 comprise a foldable structure with rotational joints 17, which allows the arm structure to unfold and extend, or to fold and retract to an arbitrary distance. The foldable arm structure comprises a number of arm sections 18 with rotational joints 17 in between. FIG. 2 (c) shows the foldable arm structure in a retracted form, whereas 2 (d) shows an extended form of the foldable arm structure. Based on the varying the number of arm sections 18, the arm is designed to suit particular distance requirements. The foldable arm structure has the claw structure 16 coupled to an end of the arm structure whereas the other end of the foldable arm structure is mechanically fixed to the safety vehicle 10 through mechanical means, such as, but not limited to, screw jacks, bolts or fasteners.

In an embodiment, the arm structures 14 are comprised of, but not limited to, steel and are capable of handling and lifting up to 10 tons of weight, to a height of 30-40 cm off the ground.

In another embodiment, the extendable and retractable arm structures 14 are actuated by a hydraulic mechanism due to which liquid fluid power is used to perform functions without the need of any additional mechanical gears or levers.

A controller is located within the safety vehicle 10 and is configured for controlling movements of the arm and the claw structures with respect to the vehicle in movement 12. The controller or control device is in the form of a joystick or multiple control buttons and is capable of navigating the extended arm structures 14 towards windows of the vehicle in movement 12. During operation, passengers or drivers within the vehicle in movement or vehicle in danger are instructed by public officers to open or roll down their windows to enable safety operations to be carried out efficiently. The claw structured ends 16 of the extended arm structures 14 are then engaged with the opened windows and the extended arm structures enable the vehicle in movement 12 to be lifted off the ground.

In accordance with another feature of the present invention, the arm structures 14 comprise at least one imaging device element for obtaining image or video data and capable of transmitting the image or video data to the controller, to assist the controller in controlling movements of the arm and the claw structures with respect to the vehicle in movement 12. An Application Programming Interface (API) at the controller enables reception of the image or video data transmitted by the imaging device element.

In an embodiment, the controller is located within the safety vehicle 10.

In accordance with yet another feature of the present invention, the arm structures 14 comprise at least one sensor. Preferably, the at least one sensor is a distance sensor or proximity sensor for sensing distance of the extended arm structures to the vehicle in movement 12, or to a window of the vehicle in movement. Data obtained using the sensors is transmitted to the controller, to assist the controller in controlling movements of the arm and the claw structures with respect to the vehicle in movement 12. The Application Programming Interface (API) at the controller enables reception of the sensor data transmitted by the distance or proximity sensors.

In an embodiment of the invention, the at least one imaging device element is located on the plurality of claw structures 16 present at the ends of each of the extended arm structures 14, for obtaining and transmitting image or video data to the controller, to assist the controller in controlling movements of the arm and the claw structures with respect to the vehicle in movement 12.

In another embodiment of the invention, the distance or proximity sensors are located on the claw structures 16 present at the ends of each of the extended arm structures 14, for sensing distance of the extended arm and claw structures to the vehicle in movement 12, or to a window of the vehicle in movement. Data obtained using the sensors is transmitted to the controller, to assist the controller in controlling movements of the arm and the claw structures with respect to the vehicle in movement 12.

The controller comprises a controller body, and a display screen is provided on the controller body for displaying information related to the data recorded and transmitted by the imaging device, and perceived by the sensors. Image and video data obtained using the imaging device is displayed on the screen in real-time which enables an officer operating the controller to accurately navigate the arm and claw structures. Also, the data perceived by the sensors, with respect to the distance or proximity of the extended arm structures 14 to the vehicle in movement 12, is evaluated by the controller to navigate the extended arm structures towards the vehicle in movement with precision. The Application Programming Interface (API) at the controller enables evaluation of the information transmitted from the imaging device and the sensors.

In another embodiment, the plurality of claw structures 16 present at the ends of each of the plurality of extended arm structures 14 is a 360-degree rotatable structure which enables the plurality of claw structures 16 to engage with windows of the vehicle in movement 12 through any direction or angle.

In another embodiment, the claw structure 16 present at the ends of each of the extended arm structures 14 is a double tooth structure and a distance between the claw teeth is fixed.

In another embodiment, the claw structure 16 present at the ends of each of the extended arm structures 14 is a double tooth structure and a distance between the claw teeth is variable. The movement of the variable claw teeth is controlled by the controller located within the safety vehicle 10, based on image or video data recorded and transmitted by the imaging device and data perceived by the sensors.

The extendable and retractable arm structures 14 with claw structured ends 16 are applicable for vehicles such as, but not limited to, motorbikes, sedans, SUVs and other four wheeled automobiles or trucks.

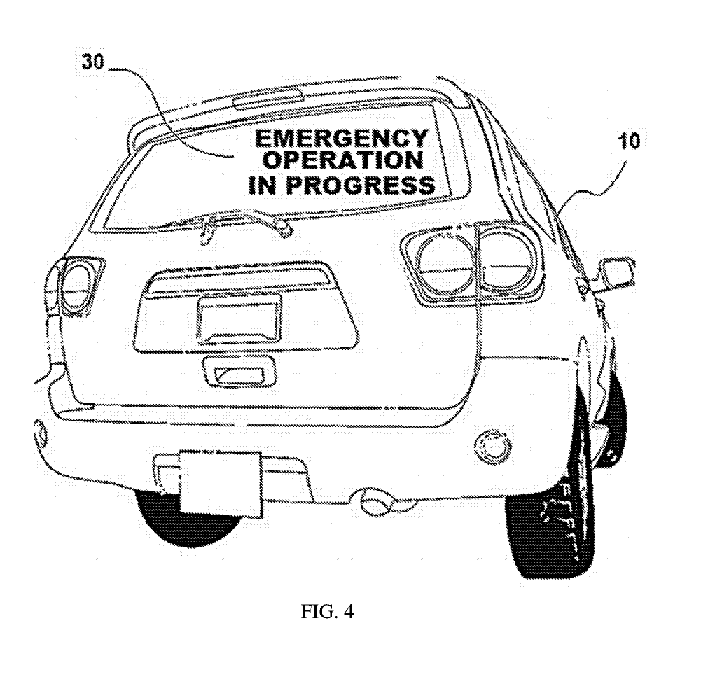

In accordance with another aspect of the present invention and as shown in FIG. 3, in addition to the extendable and retractable arm structures 14, a suction arrangement extends from the safety vehicle and attaches itself over the roof of the vehicle in movement 12 to assists in enabling the vehicle in movement 12 to be lifted off the ground. The suction arrangement comprises a telescopic rod structure 20, a plurality of suction plates 22 which adhere to the roof of the vehicle in movement when extended, and a lifting and lowering mechanism wherein the lowering mechanism presses the plurality of suction plates down on the vehicle in movement 12. A person skilled in the art will appreciate that any lifting and lowering mechanism known in the art can be used to press the plurality of suction plates down on the vehicle in movement 12. The lowering mechanism lowers the plurality of suction plates 22 onto the roof of the vehicle in movement and forcibly presses the plurality of suction plates 22 so as to attach the plurality of suction plates 22 on the vehicle in movement. One end of the telescopic rod structure 20 is fixed to the safety vehicle and the plurality of suction plates 22 are arranged at the other end of the telescopic rod structure 20. This suction arrangement assists in providing an upward lifting force in addition to the force exerted by the arm structures, hence resulting in lifting the vehicle in movement 12 off the ground.

In another embodiment, the suction arrangement comprises an imaging device element located on the plurality of suction plates 22 or on the telescopic rod structure 20, for obtaining image or video data and capable of transmitting the image or video data to the controller, to assist the controller in controlling movements of the suction arrangement with respect to the vehicle in movement 12. Image or video data obtained using the imaging device is displayed on the controller display screen in real-time which enables an officer operating the controller to accurately navigate the suction arrangement.

In another embodiment, the suction arrangement comprises distance sensors or proximity sensors for sensing distance of the plurality of suction plates 22 to the vehicle in movement 12, or to a window of the vehicle in movement. The sensors are located on the plurality of suction plates 22 or on the telescopic rod structure 20. Data obtained using the sensors is transmitted to the controller, to assist the controller in controlling movements of the suction arrangement with respect to the vehicle in movement 12. The data perceived by the sensors, with respect to the distance or proximity of the plurality of suction plates 22 to the vehicle in movement 12, is evaluated by the controller to navigate the suction arrangement towards the vehicle in movement 12 with precision.

In another embodiment, one end of the telescopic rod structure 20 is fixed on the safety vehicle's roof. The telescopic rod structure 20 is mechanically fixed on the safety vehicle 10 using screw jacks wherein the screw is, but not limited to, a machine screw or a ball screw.

In accordance with another aspect of the present invention and as shown in FIG. 4, the safety vehicle 10 comprises a display 30 on a rear window of the vehicle for exhibiting messages. An officer operating the controller located within the safety vehicle 10 is enabled to input predefined or customized messages for exhibiting the same on the display 30 which is located on the rear window or vehicle shielding glass. The Application Programming Interface (API) at the controller enables the input and display of predefined or customized messages on the display 30.

In an embodiment, the display 30 is partially deployed within the vehicle glass so as to not obstruct a driver's vision when driving the safety vehicle.

In another embodiment, the controller comprises a user interface to input text information through a customizable text entry portion. During an emergency operation, the deployed safety vehicle 10 while closely following the vehicle in movement 12, displays emergency messages on the rear window display 30 to notify other drivers that an emergency operation is in progress. This display 30 also assists the safety vehicle 10 in displaying important notifications to drivers and passengers of other vehicles traversing on the same route as the uncontrollable vehicle. An officer operating the controller located within the safety vehicle is enabled to input predefined or customized messages for exhibiting the same on the windscreen embedded display 30.

Considering a further aspect of the present invention, the safety vehicle 10 incorporated with the extendable and retractable arm structures 14 and the rear window display 30 is useful for applications including, but not limited to, robbery and kidnapping by seizing a stolen vehicle which is speeding away or a kidnapping vehicle speeding away with a victim.

Many changes, modifications, variations and other uses and applications of the subject invention will become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A safety device for lifting a vehicle in movement, the safety device comprising:
a plurality of arm structures;
a plurality of claw structures;
a controller for controlling movements of the plurality of arm and claw structures;
wherein the plurality of arm structures are extendable and retractable and fixed on a safety vehicle, wherein the plurality of arm structures extend in front of the safety vehicle when the safety vehicle is following the vehicle in movement; and
wherein the plurality of claw structures are coupled to the plurality of arm structures at one end.

2. The safety device according to claim 1, wherein the plurality of arm structures are comprised of steel.

3. The safety device according to claim 1, wherein the plurality of arm structures are fixed on left and right sides of the safety vehicle or left and right sides of the safety vehicle's roof.

4. The safety device according to claim 1, wherein the plurality of arm structures comprise a telescopic structure.

5. The safety device according to claim 1, wherein the plurality of arm structures comprise a foldable structure with rotational joints.

6. The safety device according to claim 1, wherein the plurality of arm structures are actuated by a hydraulic mechanism.

7. The safety device according to claim 1, wherein the plurality of arm structures extend simultaneously from the safety vehicle.

8. (canceled)

9. The safety device according to claim 1, wherein the plurality of arm structures comprises at least one sensor, in communication with the controller.

10. The safety device according to claim 9, wherein the at least one sensor is a proximity sensor.

11. The safety device according to claim 1, wherein the plurality of claw structures coupled with the plurality of arm structures is 360-degree rotatable structures.

12. The safety device according to claim 1, wherein the plurality of claw structures comprises a double tooth structure comprising at least two teeth, wherein distance between the teeth is fixed.

13. The safety device according to claim 1, wherein the plurality of claw structures comprises a double tooth structure comprising at least two teeth, wherein distance between the teeth is variable.

14. The safety device according to claim 1, further comprising a suction arrangement wherein the suction arrangement is extendable and retractable and fixed on the safety vehicle.

15. The safety device according to claim 14, wherein the suction arrangement comprises:
a telescopic rod structure; and
a plurality of suction plates configured to be pressed
down on the vehicle in movement when the suction arrangement is lowered;
wherein one end of the telescopic rod structure is fixed to the safety vehicle and the plurality of suction plates are arranged at an opposite end of the telescopic rod structure.

16. The safety device according to claim 15, wherein the one end of the telescopic rod structure is fixed on the safety vehicle's roof.

17. The safety vehicle according to claim 1, wherein the safety vehicle comprises a display on a rear window of the safety vehicle, wherein predefined or customized messages are displayed on the display using the controller.

18. The safety vehicle according to claim 1, wherein the controller is located within the safety vehicle.

19. The safety vehicle according to claim 1, wherein the vehicle in movement is an uncontrollable vehicle.

20. A safety system for lifting a vehicle in movement, the safety system comprising:
a plurality of arm structures;
a plurality of claw structures;
a controller for controlling movements of the plurality of arm and claw structures;
wherein the plurality of arm structures are extendable and retractable and fixed on a safety vehicle, wherein the plurality of arm structures extend in front of the safety vehicle when the safety vehicle is following the vehicle in movement; and
wherein the plurality of claw structures are coupled to the arm structures at one end;
wherein the plurality of arm structures extend towards the vehicle in movement;
the plurality of claw structures engage with an open window of the vehicle in movement; and
the vehicle in movement is lifted off the ground.
